(19) United States
(12) Patent Application Publication
(10) Pub. No.: US 2010/0077001 A1
(43) Pub. Date: Mar. 25, 2010

(54) SEARCH SYSTEM AND METHOD FOR SERENDIPITOUS DISCOVERIES WITH FACETED FULL-TEXT CLASSIFICATION

(76) Inventors: Claude Vogel, Key West, FL (US); Alkis Papadopoullos, Outremont (CA); Jean Pierre Lahargue, Pau (FR)

Correspondence Address: K&L Gates LLP, STATE STREET FINANCIAL CENTER, One Lincoln Street, BOSTON, MA, 02111-2950, US

(21) Appl. No.: 12/412,301

(22) Filed: Mar. 26, 2009

Related U.S. Application Data
(60) Provisional application No. 61/064,814, filed on Mar. 27, 2008.

(51) Int. Cl. G06F 17/30

(52) U.S. Cl. 707/777; 707/E17.014; 707/E17.015

(57) ABSTRACT

A search system and method for uncovering unexpected links between different concepts related to a user's query during a search comprise a semantic indexing server, which builds a faceted classification index of text objects, and a query server, which receives and analyzes the user's query. A query thus processed is then sent from the query server to the semantic indexing server through an interface in order to perform a search in the faceted classification index. The search system and method further comprise a result handler, which provides the user with a search result set comprising a list of unexpected links and a list of result elements. The list of unexpected links corresponds to filters which allow the user to narrow down or refine the original query.

### FIELD

The present invention generally relates to searches conducted on the World Wide Web (hereinafter the Web) or other networks. More specifically, the present invention is concerned with a search system and method for serendipitous discoveries with faceted full-text classification and/or for uncovering unexpected links between related concepts in a search.

### BACKGROUND

With the advent of the Internet and of the Web, an incredibly large amount of information is available to each user connected thereto. However, a drawback of this huge available amount of information is that it is often difficult and time consuming to find the right information, since there is so much to go through. Indeed, each page on the Web is linked to so many other pages so as to form an interconnected web.

Many search engines have been developed for conducting searches on the Web. For example, search engines are used to locate texts, images or videos stored on personal computers, corporate intranets computers and networks such as the Web using keywords. In order to simplify searches, classification is of primary importance. Indeed, a good classification generally allows for easily finding and discovering documents including keywords entered by the users.

For example, faceted metadata classification is often used to organize and present web content in e-commerce environments, where products can easily be, for presentation purposes, broken down into their respective features. The respective features are generally represented in a vector form, which allows for easily locating a particular product having those features or aspects searched by the user. Those features or aspects are typically referred to as facets.

The various facets of a product can be presented in a browsable and clickable tree structure, such as the folder structure familiar to personal computer users, which allows the user to select a desired facet. For example, the product “Home Printer” can be searched for by a user. In this case, the product “Home Printer” can be presented with the various facets characterizing a printer, such as whether the printer is color or monochrome, inkjet or laserjet technology, installable on networks or not, name of the manufacturer, etc. The number of the product characteristics is finite, predictable and easy to model, therefore, it is easy to obtain a feature vector of the product for searching purposes. However, this is not the case for full text objects, such as text documents found on the Web. Indeed, a full text object can include a large number of unexpected, interrelated and combined conceptual units.

Therefore, there is a need of overcoming the above-discussed drawbacks related to classifying and searching text objects. Accordingly, a search system and method using a faceted classification of text objects for uncovering unexpected links between different concepts related to a query are sought.

### SUMMARY

More specifically, according to a first aspect, there is provided a method for conducting a query-based search in documents provided on a network, the method comprising:
classifying text objects contained in the documents using a faceted classification;
determining a precursor in a query;
identifying the determined precursor in the faceted classification; and
upon identification of the determined precursor in the faceted classification, returning both a set of text objects related to the identified precursor and a set of unexpected results defined by facets and facet values associated with the determined precursor.

More specifically, according to another aspect, there is provided a system for conducting a query-based search in documents provided on a network, the device comprising:
means for classifying text objects contained in the documents according to a faceted classification;
means for determining a precursor in a query;
means for identifying the determined precursor in the faceted classification; and
upon identification of the determined precursor in the faceted classification, means for returning both a set of text objects corresponding to the identified precursor and a set of unexpected results defined by facets and facet values associated with the determined precursor.

More specifically, according to another aspect, there is provided a system for conducting a query-based search in documents provided on a network, the device comprising:
a semantic indexing server so configured as to classify text objects contained in the documents according to a faceted classification;
an identifier so configured as to determine a precursor in a query;
a query server so configured as to identify the determined precursor in the faceted classification; and
a result handler so configured as to return both a set of text objects related to the identified precursor and a set of unexpected results defined by facets and facet values associated with the determined precursor.

The foregoing and other objects, advantages and features of the present invention will become more apparent upon reading of the following non-restrictive description of illustrative embodiments thereof, given by way of example only with reference to the accompanying drawings.

### BRIEF DESCRIPTION OF THE DRAWINGS

In the appended drawings:

FIG. 1 is a schematic diagram of a tree-type structure of the taxonomies and ontologies used in a search system according to a non-restrictive illustrative embodiment of the present invention;

FIG. 2 is a schematic block diagram of a non-restrictive illustrative embodiment of the search system for uncovering unexpected links during a search;

FIG. 3 is a schematic block-diagram of the semantic indexing server in the search system of FIG. 2;

FIG. 4 is a schematic block-diagram of the query server in the search system of FIG. 2;

FIG. 5 is a schematic block-diagram of the result handler in the search system of FIG. 2;

FIG. 6 is a flow chart of a non-restrictive illustrative method for uncovering unexpected links during a search;

FIG. 7 is a flow chart of the semantic indexing process in the method of FIG. 6;

FIG. 8 is a schematic representation of each step in the semantic indexing process of FIG. 7;

FIG. 9 shows an example of the display of the result set obtained through the search system of FIG. 2;

FIG. 10 is an example of the display of the result set of FIG. 9, which has be refined;

FIG. 11 is a schematic diagram illustrating a simple query using the search system of FIG. 2;

FIG. 12 is a schematic diagram illustrating another simple query using the search system of FIG. 2; and

FIG. 13 is a schematic diagram illustrating an example of a multi-concept query using the search system of FIG. 2.

### DETAILED DESCRIPTION

It is to be noted that before describing illustrative embodiments of the present invention, a glossary of technical terms is provided so as to help construe properly the technical terms used therein.

### Glossary of Technical Terms

Data structure: it is a scheme for organizing and storing information data; examples of data structure are lists, tables, etc.;

Facet: it corresponds to a feature of an object; in case of a text object, it can represent a concept, a tag to the concept or to a category of topics;

Faceted classification: classification allowing the assignment of multiple classifications (or facets) to an object, enabling the classifications to be ordered in multiple ways, rather than in a single, pre-determined, taxonomic order;

Facet value: it is used to describe a facet;

Metadata: it is a piece of data used to describe a content of data;

Node: in tree structures, it is a point where two or more lines meet;

Ontology: it is a rigorous and exhaustive organization of some knowledge domain that is usually hierarchical and contains all the relevant entities and their relations;

Parsing (or syntactic analysis): it is the process of analyzing a sequence of tokens to determine the grammatical structure of the tokens with respect to a given formal grammar; a parser is the component of a compiler that carries out this task;

Reverse index: it is a data structure where all documents containing a particular word are stored, instead of storing the location of all words in a given document;

Taxonomy: it is the art of classification of things, which are frequently arranged in a hierarchical structure, typically related by subtype-supertype relationships, also called parent-child relationships; in particular, it can be applied to a classification of different concepts having a Genus to Species relation; and

Token: it is a categorized block of text (or text object) obtained through the lexical analysis, which consists of converting a sequence of characters into a sequence of tokens; programs performing lexical analysis are called lexical analyzers or lexers; for example, a lexer consists of a scanner and a tokenizer.

Generally stated, a search system according to a non-restrictive illustrative embodiment of the present invention allows not only to find results based on semantic concepts in response to a user's query but also to uncover unexpected links, which the user has never thought of or even imagined, between different conceptual units related to the user's query within a collection of documents. Also, by building a semantic index, through taxonomies and ontologies, it is possible for the user to extend or refine his/her search within the results given by the original search.

### The Structure of the Taxonomies and Ontologies

Before describing the search system according to a non-restrictive illustrative embodiment of the present invention, the structure of the taxonomies and ontologies which are used within the search system for semantic indexing will first be described. However, it should be noted that the taxonomies and ontologies will be referred to as the taxonomies 40 in the following description since they work together to obtain a representation of text objects in the form of a structured classification, which is generally hierarchical.

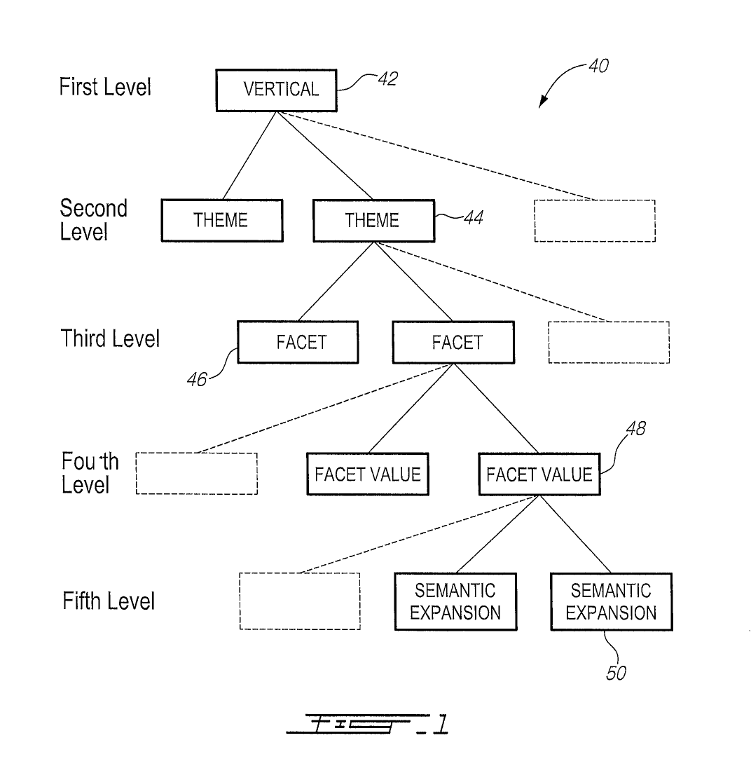

Turning now to FIG. 1, a tree-type of structure is used for the taxonomies 40.

The first level of the tree-type structure of the taxonomies 40 is represented by a vertical 42, which generally corresponds to a large topic of interest, such as Politics, Health, News, Sports, etc.

It should be noted that the taxonomies 40 comprise a plurality of such verticals 42, even though only one vertical 42 is shown in FIG. 1.

The second level of the tree-type structure of the taxonomies 40 corresponds to a theme 44, attached to the vertical 42, called the parent vertical 42 in this case. The theme 44 represents a more specific topic within the parent vertical 42. Generally, a plurality of themes 44 is associated to each vertical 42 (however only two themes 44 are shown in FIG. 1). For example, themes 44 related to the vertical 42 of Health can be Diseases, Alternative Medicine, Well-being, etc.

Furthermore, for each vertical 42, a specific thesaurus is used for further developing the classification of each of the themes 44 so as to obtain a deeper ramification of the tree-type structure of the taxonomies 40. The classification includes subsequent levels, such as facets 46, facet values 48 and semantic expansion 50.

The facets 46, corresponding to the third level of the tree-type structure of the taxonomies 40, represent particular features or aspects of their associated theme 44. For example, in the vertical 42 of Politics, the theme 44 called Elections may be associated with that vertical. And under the theme 44 of Elections, different facets 46, such as Political Parties, Candidates, Lobbying, Political Campaign, etc., may be found to be attached to the theme 44 of Elections.

Each facet 46 is the parent of a set of associated facet values 48 (only two facet values 48 are illustrated in FIG. 1), which are used to describe their parent facet 46 and are located in the fourth level of the tree-type structure of the taxonomies 40.

Finally, at the fifth level of the tree-type structure of the taxonomies 40, one can find the semantic expansion 50 associated to each facet value 48.

For example, in the facet 46 of Political Campaign, a corresponding facet value 48 may be Campaign Finance, and under such facet value 48, semantic expansion 50 such as Campaign Finance Reform, Campaign Finance Fraud, Campaign List Contributors, etc., may be attached.

Such a tree-type structure of the taxonomies 40 allows for building a faceted classification of documents so that related concepts are linked between each other. Using such a classification, relevant concepts associated with a user's query can be determined as will be explained hereinbelow.

More specifically, the facet 46 and its associated facet values 48, which are linked to a head concept related to the user's query, are presented to the user as the results of the query search. Those facets and associated facet values yield the unexpected links between concepts related to the user's query.

Also, it should be noted that each vertical 42 allows for defining a topic-specific taxonomy. In addition, the taxonomies 40 can also comprise global taxonomies, meaning that some keywords or concepts are not associated with any vertical 42. Furthermore, Associated Terms (AT) and Related Terms (RT) between different concepts, represented by a node in the tree structure of the taxonomies 40, can be defined so that links to each other can be made. Those links between different nodes of the taxonomies 40 allow for crossing over different concepts and combining them so as to contribute to uncover unexpected links between different concepts related to a user's query.

For example, an AT can define a link between different terms which are part of a same taxonomy, therefore, they are semantically related, but they may not be part of a same vertical 42. As a practical example of ATs, the terms “automobile” and “hybrid” can be linked together through an AT, since those two terms can be found in different verticals of a taxonomy but they can be also semantically related.

An RT can define a link between different terms, which are not semantically related to each other but which yield either a cultural, contextual, or linguistic relation between the terms. Those terms are generally found in the same taxonomy. As a practical example of RTs, the terms “global warming” and “hybrid” can be linked together through an RT since they can define a cultural or contextual relation between each other.

The structure of the taxonomies 40 is able to determine such links between the different terms.

### The Search System

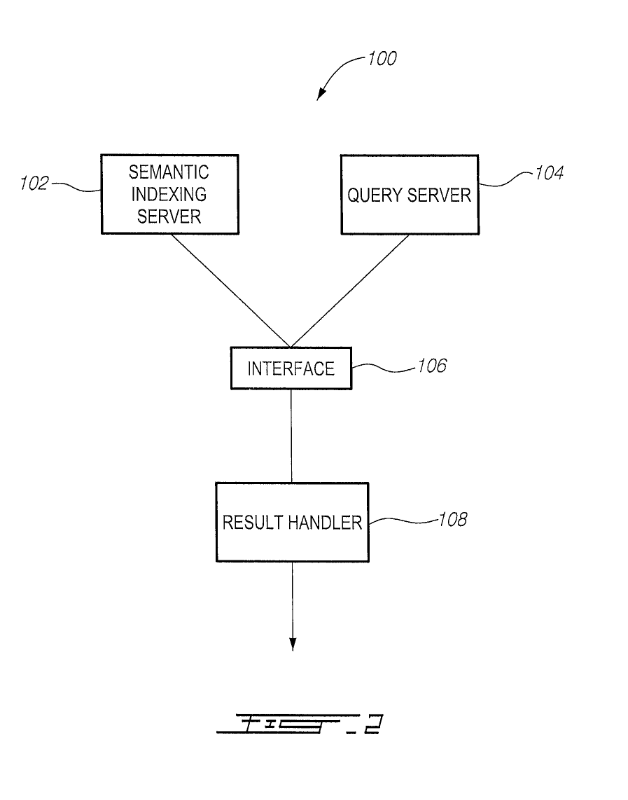

Now turning to FIG. 2, a non-restrictive illustrative search system 100 for discovering or uncovering unexpected links between different concepts related a user's query during a search will be described.

More specifically, the search system 100 includes a semantic indexing server 102, and a query server 104, both of them connected to an interface 106, which is in turn connected to a result handler 108.

The semantic server 102 pre-processes the data, i.e. indexing a collection of text objects according to their conceptual units and storing them in a semantic index. This index is used to match the queries from the users and for discovering related concepts. Of course the search system 100 may include more than one semantic indexing server 102.

The query server 104 receives and processes the queries coming from the users.

The interface 106 allows the query server 104 to communicate with the semantic indexing server 102. It is then possible for the query server 104 to access the semantic indexing server 102 so as to perform a search using the queries entered by the users.

Finally, the result handler 108 provides the user with the results of the search conducted through the search system 100, by calculating the most relevant found semantic concepts. The results can be further narrowed down through the result handler 108 so as to focus more specifically the search within a combination of related concepts, as will be explained hereinbelow.

Now, each element of the search system 100 will be described in greater details.

### The Semantic Indexing Server

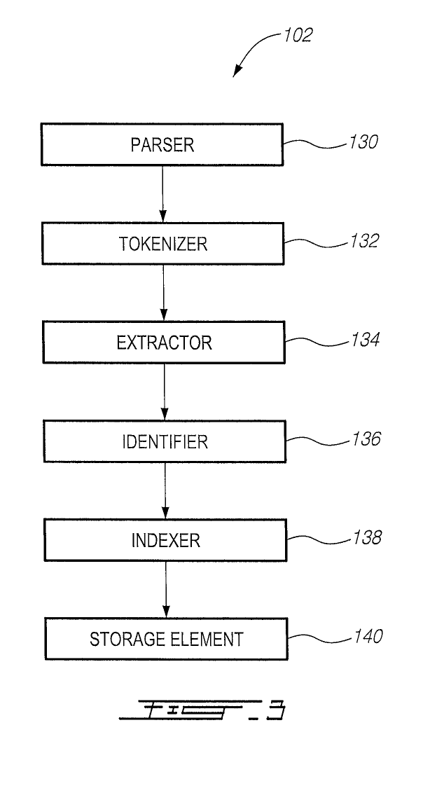

As illustrated in FIG. 3, the semantic indexing server 102 includes a parser 130, a tokenizer 132, an extractor 134, an identifier 136, an indexer 138 and a storage element 140, for building an index of faceted classification of text objects, which can be searched through for answering the queries from the users. The semantic indexing server 102 also uses the taxonomies 40 for building the faceted classification, as described above.

The parser 130 separates a text document into structural and individual text elements or text objects.

The tokenizer 132 converts each text object or text element supplied by the parser 130 into a token or a group of tokens. Furthermore, each token or group of tokens can be analyzed by the tokenizer 132 so as to extract conceptual units contained therein.

The parser 130 and the tokenizer 132 are believed to be well-known devices in the art and will not be further described.

The extractor 134 is used to extract the conceptual unit from each token or group of tokens, supplied by the tokenizer 132.

The identifier 136 is then used to determine a head concept or precursor from the extracted conceptual units provided by the tokens.

Also, a second identifier (not shown) can be used for identifying concepts in the tree-type structure of taxonomies 40, which are related to the precursors identified by the identifier 136.

The indexer 138 indexes the tokens or the corresponding text objects, according to their conceptual units and associated semantic tags, to each of their precursors such that a faceted classification of the text is obtained.

Finally, the storage element 140 stores the tokens together with their corresponding precursors and associated semantic tags in such a way that it is possible to uncover unexpected links between different concepts related to the user's query during a search in the semantic index, as will be described below.

### The Query Server

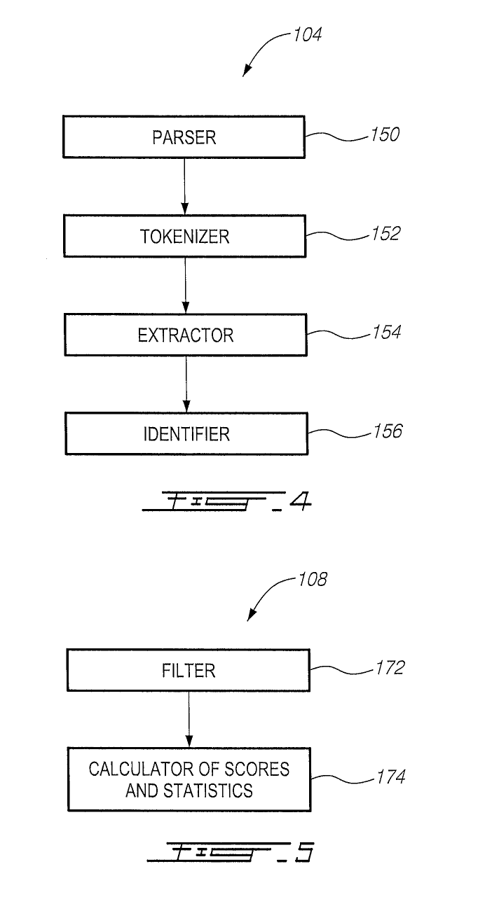

Turning to FIG. 4, the query server 104 includes a parser 150, a tokenizer 152, an extractor 154 and an identifier 156, for identifying precursors in the queries entered by the users.

The parser 150, the tokenizer 152, the extractor 154 and the identifier 156 are substantially the same as those described in the semantic indexing server 102. They also perform substantially the same task, respectively. In this case, the parser 150, the tokenizer 152, the extractor 154 and the identifier 156 work together so as to extract the conceptual units and determine the corresponding head concepts or precursors contained in the queries, provided by the tokens, entered by the users.

### The Interface

The interface 106 allows the query server 104 to access the semantic indexing server 102 so as to transmit the processed queries from the users to the semantic indexing server 104.

### The Result Handler

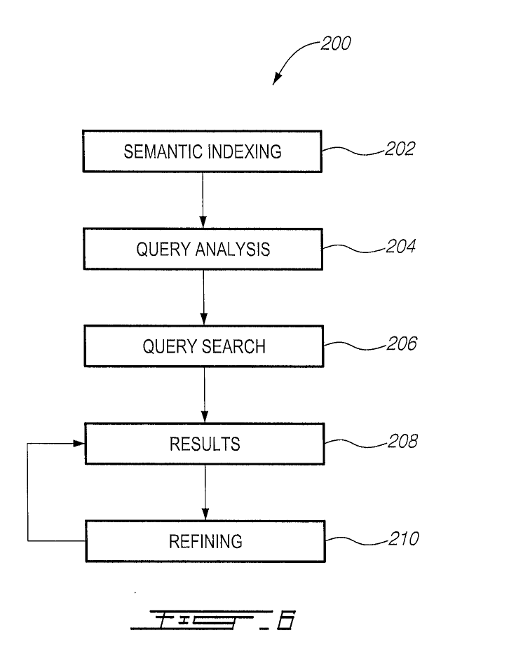

Turning to FIG. 5, the result handler 108 includes a filter 172, and a calculator of scores and statistics 174.

The filter 172 retrieves relevant answers from the indexing server 102 in response to the queries analyzed by the query server 104.

The calculator of scores and statistics 174 scores and ranks the answers obtained through the filter 172. The calculator 174 can use a distance function for scoring and ranking the answers. For example, the calculator 174 can use a simple proximity function known in the art to do so. However, the calculator 174 can also use more complex functions to evaluate the scores and ranks of the answers, especially in the case when the collection of documents available for searches is large. As examples, the more complex functions can include a mutual information function, a residual inverse document frequency (IDF) function, or a document genre and tone analysis.

During a search, the precursors contained in a query are matched with nodes in the global and topic-specific taxonomies and ontologies. When there is a match, the precursors are linked with their corresponding nodes. It is then possible to determine which facets of the ontologies and taxonomies 40 should be retained as potential candidates to be presented to the users, as will be explained hereinbelow. Furthermore, since each facet is linked to a plurality of facet values, those facet values are also shown to the users.

The facets and their associated facet values presented to the users can be used as filters for filtering the results so as to narrow down the search results. Also, those facets and their associated facet values correspond to the unexpected links presented to the users.

### The Search Method

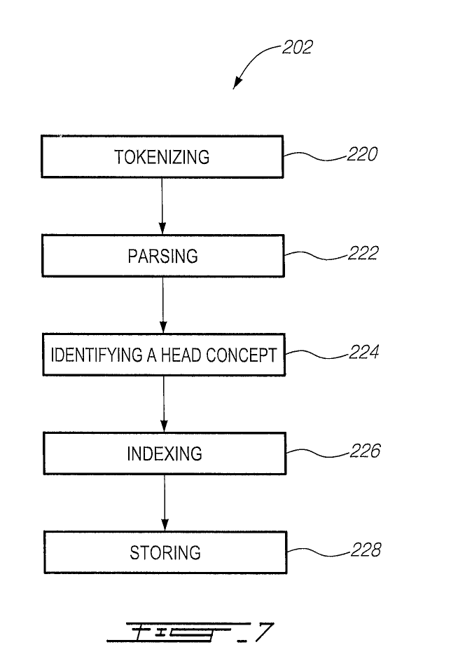

Turning to FIG. 6, a search method 200 for uncovering unexpected links between different concepts related to a user's query during a search will be now explained hereinbelow, with reference to FIGS. 2 to 5.

The method 200 starts with semantic indexing in operation 202 in order to generate an index of classified text objects, using a faceted-classification, through the semantic indexing server 102. Of course, the semantic indexing operation may take place well before the search queries are entered by users. Also, the semantic indexing operation may be ongoing, adding text objects to the collection on regular basis.

In operation 204, the query provided by the user is analyzed through the query server 104 so as to extract the conceptual units contained in the query for a search thereof.

In operation 206, the search is conducted in the search system 100 using the index constructed in operation 202, via the interface 106.

Next, in operation 208, a set of search results is obtained through the result handler 108.

In operation 210, the set of search results is divided into two lists. A first list includes the unexpected links uncovered during the search and which are used to filter the result elements which are provided by a second list. Therefore, the set of search results can be presented to the user in the form of a browsable tree structure, displaying the list of unexpected links between different concepts in a first column and the list of result elements in a second column, for example. The list of unexpected links are organized into categories (given by the facets 46) and their corresponding sub-categories (given by the facet values 48), for example. The user can then refine and narrow down the set of search results to one of the specific sub-categories listed in the first column, for example. To do so, the user can just click on the related concept that he/she is interested in (for example a particular item in a sub-category), from the first list of unexpected links uncovered during the search. Then, the results corresponding to that sub-category are displayed in the second column from the second list of results. The user can always go back to the original search results by clicking back on the category corresponding to the sub-category clicked by the users, in the list of unexpected links

Now, each operation of the method 200 will be explained in detail.

### Operation 202: Semantic Indexing

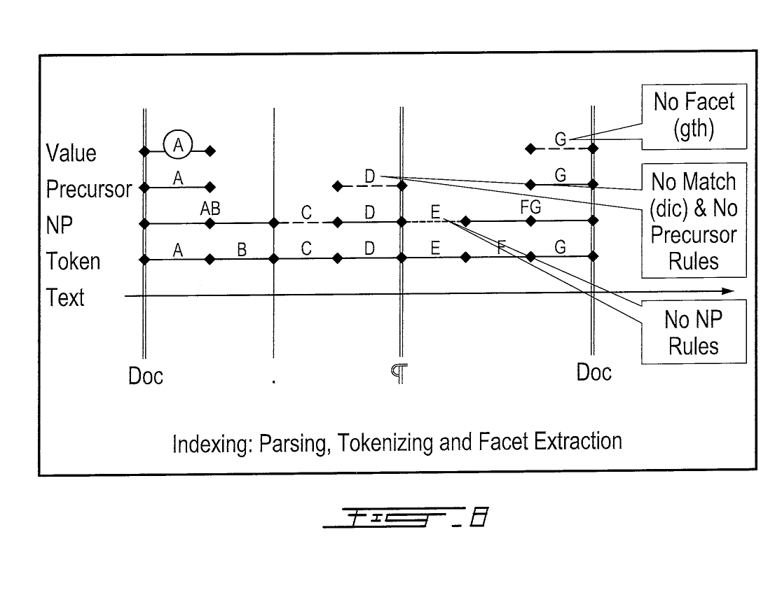

FIG. 7 schematically illustrates the semantic indexing processing 202 of a collection of text objects. The semantic indexing includes tokenizing (operation 220), parsing (operation 222), identifying a head concept (operation 224), indexing (operation 226) and storing (operation 228) the text objects in the storage element 140 in the form of a reverse index.

For example, text objects are a collection of symbols organized into words, which are grouped into sentences. The sentences, with the use of punctuation marks, form paragraphs. The text objects are typically made up of several such paragraphs, to thereby form a complete text document.

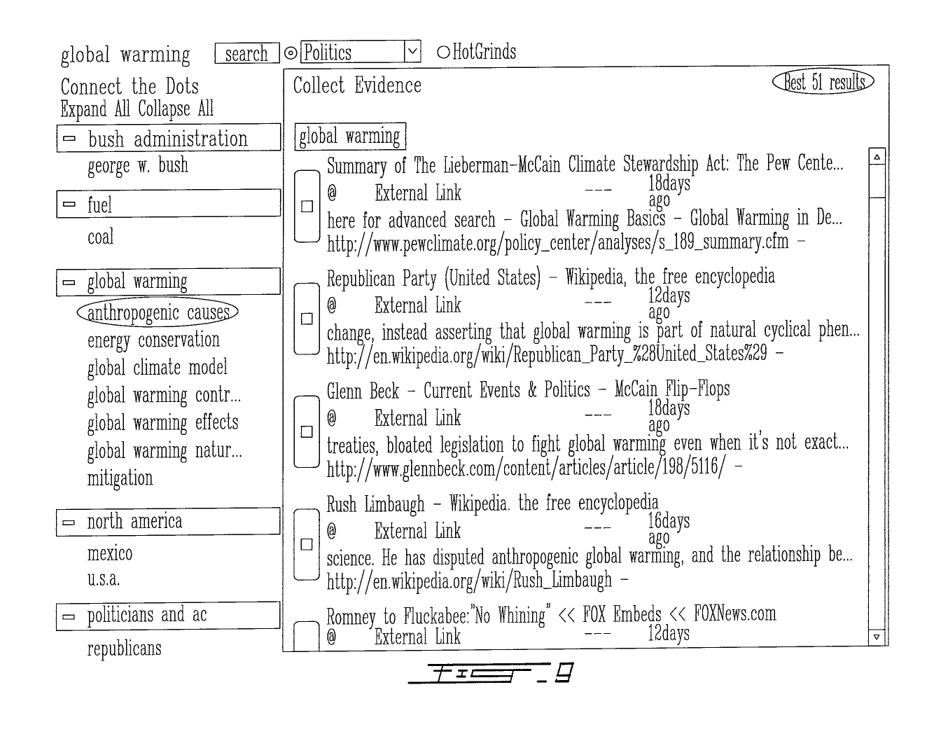

In the diagram of FIG. 8, the lowest horizontal axis schematically represents a typical text object, whereas the vertical axis in the diagram represents the different steps of semantic indexing applied to the text object, as will be explained hereinbelow.

Also, each text object being processed during semantic indexing is first identified and associated to a specific theme 44 attached to a vertical 42 of the taxonomies 40, using a vertical metatag, for example. Therefore, each text object is assigned to a specific-topic taxonomy, which identifies the main topical content thereof.

In operation 220, the text object is tokenized, meaning that the main structural elements in the text objects are identified and then separated into individual elements, called tokens, to thereby obtain a sequence of tokens, such as A, B, C, D, E, F and G as illustrated in FIG. 8. Tokenizing is done through the tokenizer 132.

Next, in operation 222, the sequence of tokens is parsed using the parser 130 so as to extract the conceptual units contained in the tokens. More specifically, the sequence of tokens is analyzed so as to determine whether the tokens form a valid noun-phrase (NP), an idiomatic expression, a collocation, or just a single word, such as a keyword, each of the terms representing a conceptual unit. For example, as can be seen from the line labeled “NP” (noun-phrase) in FIG. 8, tokens A and B form a valid noun-phrase, so do tokens F and G, however tokens C, D and E are only simple keywords or expressions. Using more practical examples, the noun-phrase AB can represent the conceptual unit of “laser printer”, and the noun-phrase FG “patent law”, the token D can be an idiomatic expression such as “burn the midnight oil”.

In operation 224, for each valid combination of tokens including a conceptual unit, a head concept, called precursor, is further determined using a binding process through the second identifier (not shown), for example. For example, in the noun-phrase AB corresponding to “laser printer”, the determined head concept would be “printer”; in FG corresponding to “patent law”, the head concept would yield “law”; and in D corresponding to “burn the midnight oil”, the head concept would be “burn the midnight oil” since this is an idiomatic expression, i.e. the meaning of the expression cannot be interpreted from each of its individual words. As illustrated in FIG. 8, the resulting precursors thus determined are given by p(A)=(“printer”) for the noun-phrase AB, p(D)=(“burn the midnight oil”) for the expression D, and p(G)=(“law”) for the noun-phrase FG. There are no precursors determined for C and E, which are simple keywords.

More specifically, the binding process associates a precursor to an expression, in form of tokens, occurring in a text document. This can be accomplished as follows.

First, the topic-specific taxonomies within the ontologies and taxonomies 40 relevant to each of the expression of the text document are determined. The top-specific taxonomies that match the theme and the vertical metatag assigned to each text object are considered to be relevant.

Then, a hash table of concepts defined in the relevant topic-specific taxonomies can be used to identify potential matches with the expression in the text document. Once a series of reasonable candidates has been identified, the surrounding expressions of the text document are also analyzed so as to also yield potential matches or semantic reinforcement in the taxonomies 40 or topic-specific taxonomies. Then, a distance function computation is used to determine which candidate of the series of reasonable candidates is most likely the head concept of the expression, i.e. the head concept that is believed to best represent the expression in its intended meaning within the context of the text document.

Next, in operation 226, indexing and linking each text object to its respective relevant concepts identified in the topic-specific taxonomies during operation 224 are performed by applying category tags, corresponding to the respective relevant concepts of the topic-specific taxonomies, to each of the text object.

More specifically, the category tags or semantic tags correspond to the facets 46, which represent a conceptual unit contained in the text object processed. For example, in FIG. 8, a facet value fv(A) from one of the relevant topic-specific taxonomies has been applied to the precursor p(A); however, for D, there was no facet value applied, meaning that D does not have any facet value in any of the relevant topic-specific taxonomies. As mentioned hereinabove, a facet value is a child of its associated facet, and is used to describe this parent facet so as to further expand the concept.

Referring back to FIG. 1, each level of the tree-type of structure of the taxonomies 40 is represented by a node. Nodes located at the same level are siblings of each other, they can be referred to as synonyms as well. For example, all the facet values 48 associated to a node facet 46 are siblings with each other. The node facet 46 represents a key conceptual unit, associated to a precursor.

The precursors, which were determined in operation 224 by the parser 130 for example, are then matched with the nodes (facets 46) in their respective topic-specific taxonomies. If there is a match, then the precursor is linked to that node 46.

Furthermore, each time that a precursor is linked to a node, a cluster of additional information is linked to the precursor as well, such as where in the taxonomies 40 the expression/tokens occur, who are the siblings, or the children, or how many facets are related to that precursor, etc. as will be explained hereinbelow.

Once all the text objects have been processed in the semantic indexing server 102, the results of indexing are stored in the storage element 140 in the form of a reverse index, in operation 228. The reverse index shows all the connections and associations of conceptual units related to a particular precursor.

More specifically, storage of the reverse index is performed as follows, in reference with the above given examples and FIG. 8:
Every text object, such as the noun-phrase AB, is stored in the reverse index at a given position along with its text object identification tags, such as the vertical metatag corresponding to the theme of the text object;
Facet value fv(A) is associated to the noun-phrase AB as a semantic tag and is therefore stored at the same given position in the reverse index;
The parent facet f(A) 46 of the facet value fv(A) 48, corresponding to the precursor p(A), is also stored in the reverse index as a category tag for this particular text object;
All the siblings of facet value fv(A) that have been identified during the indexing process of the text document are also stored in the reverse index at the same given position than the noun-phrase AB; those siblings contribute to reinforcing the semantic strength of their corresponding parent facet 46; this reinforcement can be used to determine which facets and facet values will be presented to the user in response to a query;
Tokens C and E are stored in the reverse index as simple keywords along with their text object identification tags at other given positions in the reverse index;
Token D is stored as a conceptual unit at another given position along with its text object identification tag; however, in this case, there is no facet value 48 or facet 46 associated thereto; therefore, D can corresponds to a stand-alone conceptual unit, which does not belong to any topic-specific taxonomies;
The noun-phrase FG is stored in the reverse index at a further given position along with its text object identification tag; and
A conceptual unit G is associated as a semantic tag to the noun-phrase FG in the reverse index and is stored at the same position as FG; however, there is no facet value 48 nor facet 46 associated with FG.

It should be noted that concepts which are crossed-over in the taxonomies through related terms (RT) and/or associated terms (AT) can be also used for reinforcement of the semantic strength of a facet or precursor. Those links, RT and AT, are determined in the structure of the taxonomies 40, by using statistical analysis of the frequency of co-occurrence of the different related or associated terms in documents or queries, for example. Also, they are generally considered for semantic reinforcement when determining the precursors contained in the text objects.

Once the reverse index is built using a faceted classification of the text objects, the reverse index is ready to be used for answering the queries from the users.

However, it should be understood that there are other ways to store the processed text objects, such as using regular databases, tabular lists, etc. Of course these storing solutions should offer the same ability of storing a semantic index in such a way as to enable the users to narrow down and refine their search results easily and efficiently.

### Operation 204: Query Analysis

When a user wants to initiate a search, a series of keywords are entered. These keywords are referred to as a query string, which is then submitted to the query server 104. Upon receiving this query string, the query server 104 performs an analysis on the text objects contained in the query string in order to determine the conceptual ideas provided by the text objects. Therefore, essentially the same operations as described in the semantic indexing (operation 202) are performed on the query string.

First, the query string is tokenized and parsed. Then, the conceptual units and precursors in the text objects are determined. The precursors are identified along with their corresponding links to facets and facet values using the taxonomies and ontologies.

Once the precursors in the query string are determined, the query string is reformatted and put into query data structures, comprising two lists: a list for containing the identified query elements and another list for containing the filtering elements.

For example, the query elements may include the determined keywords, noun-phrases, precursors, facet values, facets, or even user names, etc.

The filtering elements may include the actual vertical 42 and/or theme 44 corresponding to the query's keywords, the facets and their associated facet values.

### Operation 206: Query Search

The two lists corresponding to the reformatted query string are then submitted to the interface 106, which has access to the semantic indexing server 102 for searching purposes in the reverse semantic index.

Each element from the query element list is searched in the reverse semantic index. Each time that a match is found between the query element and a text object in the reverse index, the query elements and the corresponding identified text objects are accumulated in an answer set. For example, the matching process can use a facet as the matching criterion.

It should be noted that in addition to the text objects having facets directly linked to the query elements or precursors, text objects with related facets from related precursors can be also accumulated in the answer set.

For example, suppose that a noun-phrase AB yields two precursors p(A) and p(B), which are associated with facet values fv(A) and fv(B) respectively. When a user enters a query for the term A, text objects containing fv(A) will be identified and accumulated in the answer set. However, through the link between the precursor p(A) and the noun-phrase AB, it can be inferred that text objects containing fv(B), which are also linked to the noun-phrase AB, may be of potential interest to the user, therefore, the text objects containing the facet values fv(B) are also accumulated in the answer set.

Of course, in case where a noun-phrase AH exists and has been indexed by the semantic indexing server 102 of FIG. 2 and which yields a precursor p(A) and a precursor p(H), the text objects containing facet values fv(H) associated with p(H) will also be accumulated in the answer set, when the user enters the query for the term A.

Furthermore, for all the facets identified through direct links or inferred from the direct links, their respective corresponding facet values are also identified. Then, the text objects associated with those facet values are also accumulated in the answer set. This is called synonym aggregation.

By so doing, it is then possible to present to a user, in response to a given query, combination of concepts semantically related to the given query so as to allow the user to discover semantically linked information.

Once all the elements of the query element list have been searched, the resulting answer set and the filtering elements are submitted to the result handler 108.

### Operation 208: Results

Upon receiving the list of filtering elements, the filter 172 of FIG. 5 is applied to the answer set. The elements in the answer set that do not correspond to the filtering elements are removed from the answer set.

For example, a filtering element can correspond to a particular vertical 42. In this case, the elements or text objects in the answer set, which do not belong to that particular vertical 42, are removed from the answer set. Also, other filtering elements, such as user's preferences, can be used to filter out elements from the answer set.

Furthermore, for each element remaining in the answer set, a score and a statistical analysis are performed through the calculator of scores and statistics 174 (FIG. 5) so as to determine the most relevant facets to present to the user, in response to the submitted query.

The calculator of scores and statistics 174 uses a distance function or a proximity function within the taxonomies 40 to score and rank each element in the answer set.

Also, the frequency of occurrence of each element within the same document is computed through the calculator of scores and statistics 174.

The elements which obtained the highest scores and ranks and/or the elements that occur the most frequently in the documents are included in the search result set, which will be presented to the user. Also, the facets and facet values linked to the precursors extracted from the query string are included in the search result set.

### Operation 210: Refining

Once the search result set is obtained, which includes a list of unexpected links and a list of result elements, the search result set is displayed in such a way that they are interactive with the user. Usually, the list of result elements and the list of unexpected links are presented in a browsable, clickable tree structure, such as the familiar folder structure in personal computers, which allows the user to select specific facets of interest in the list of unexpected links, so as to refine the query. Indeed, the list of unexpected links, uncovered during the search allows the user to explore and discover different combinations of concepts related to the original query.

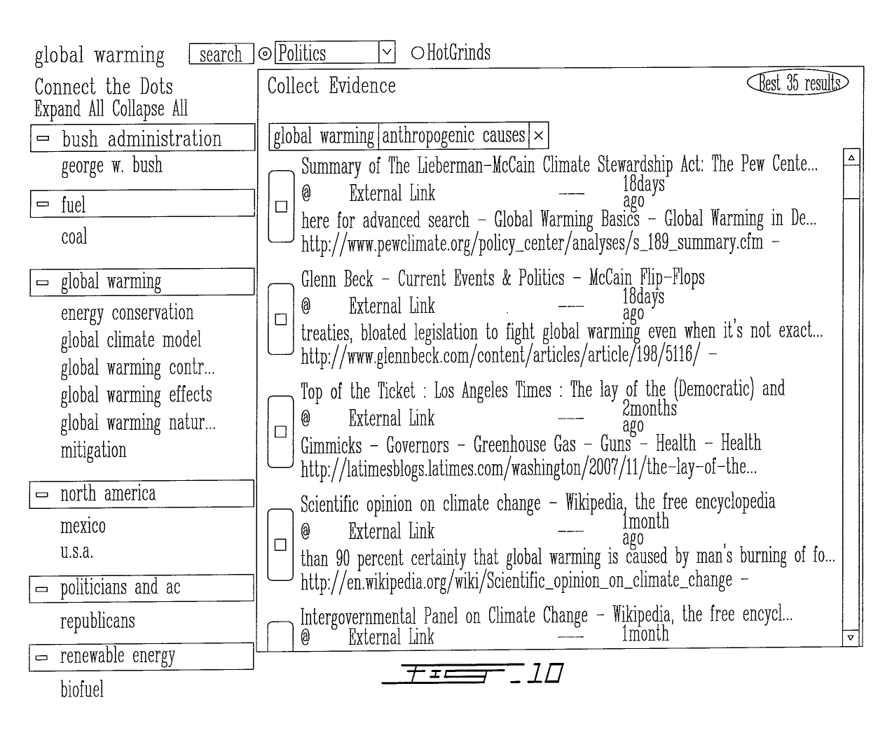

FIG. 9 illustrates an example of such a result display. The query entered by the user was “global warming”. The search system 100 returned 51 results which are then presented to the user. Under the facet “global warming” (at the left of FIG. 9), a list of facet values associated with the parent facet are displayed, such as “anthropogenic causes”, “energy conservation”, “global climate model”, etc.

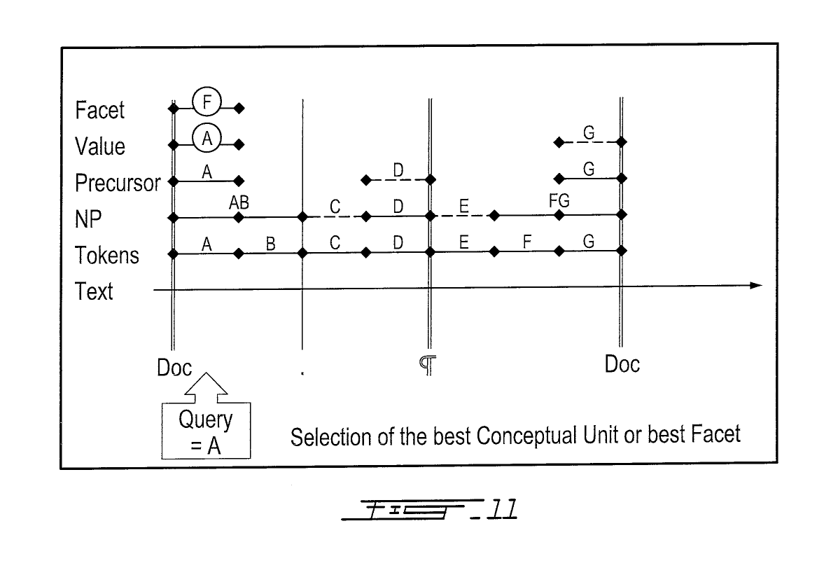

In order to refine the query, the facet value chosen by the user is added to the filtering list in the filter 172. Therefore, elements in the search result set that are not related to that added facet value are removed from the result set, so that the user is presented with narrower search results corresponding to the selected facet value of interest. However, the user can go back to the previous and larger search result set and then choose another facet value to explore, and so on and so forth. For example, FIG. 10 shows the results when the user decides to refine his/her search by clicking on a particular facet value such as “anthropogenic causes” under the facet of “global warming”. By so doing, the number of results returned by the search system 100 is reduced to 35. The user can click on any of the facet values listed at the left of FIG. 10 in order to refocus his/her search with another combination of semantically related concepts. It should be noted that each facet value or facet selected by the user can be accumulated in the filter list of the filter 172. These accumulated facets and facet values can be then logically added (logic AND operation) so as to refine deeper and further the user's query or to be analyzed for further processing, for example.

At any time, the user can save the results of his/her query by using a save function.

### EXAMPLES

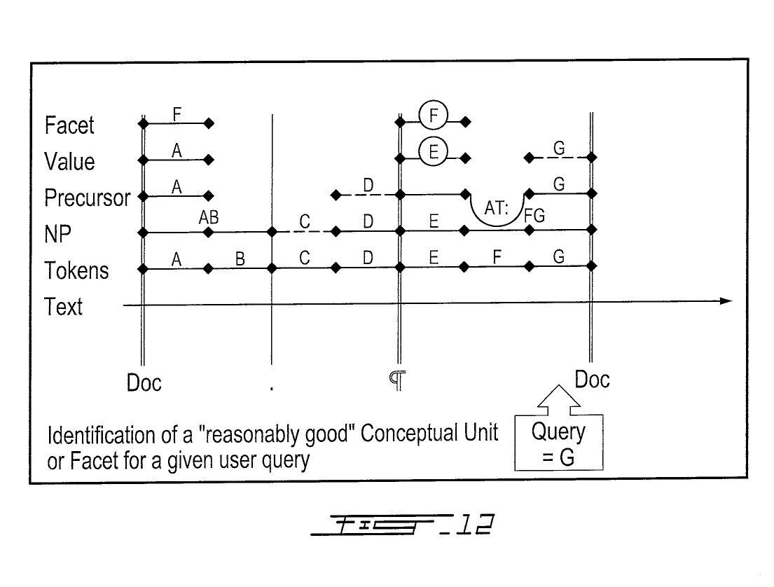

Now turning to FIG. 11, an example of a simple search is illustrated.

The user enters a query for the term A through the interface 106, which is then analyzed by the query server 104 and submitted to the semantic indexing server 102. In this case, the text objects that contain the precursor p(A) are identified, the precursor p(A) being derived from the noun-phrase AB. This precursor is generally linked to a facet in the reverse index. Therefore, the search result set will return the text objects containing the precursor p(A), the facet f(A) that is associated with the precursor p(A) as well as the facet values fv(A) associated with the facet f(A) and which occurred in the documents.

Also, it is possible to have a same precursor which is derived from two NPs, for example. In this case, the search result set will return the text objects containing the precursor, and the facets and facet values associated to this precursor. The search result will also return the text objects that contain the two noun-phrases for example.

As a practical example, a first NP can be “printer cartridge” and a second NP can be “printer model number”, then both of the NPs will yield the same precursor “printer”. The text objects that will be retained for presentation to the user will include text documents that contain both of the two NPs.

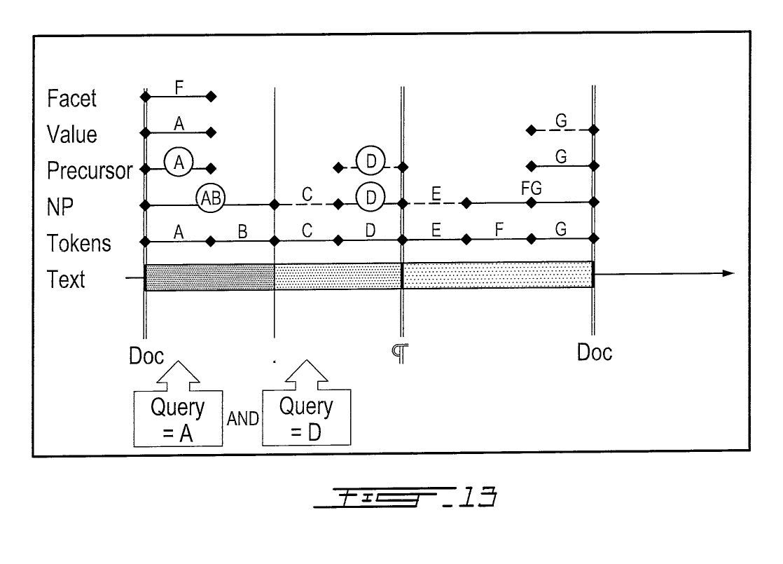

FIG. 12 illustrates another simple query. This time, the user enters a query for the term G. In this case, no text object containing the precursor p(G) is found. The precursor p(G) is part of the global ontologies and taxonomies 40 but does not belong to any topic-specific taxonomy, for example. Since no text object containing the precursor p(G) has been found, there is no identification of an associated facet or facet values. However, it can be seen in FIG. 12 that the term G is linked to a precursor p(E) through an Associated Term (AT), which belongs to a particular topic-specific taxonomy. The precursor p(E) is linked to a facet f(E) and associated facet values fv(E). Therefore, the user will be presented with the term G along with the facet f(E) and its associated facet values fv(E).

As a practical example, a user enters as query terms the following expression “dinosaur in a haystack”. During precursor extraction in the query server 104, the precursor “dinosaur” is extracted. This precursor can be part of the global taxonomies but not in a particular topic-specific taxonomy, because the vertical of the paleontology topic does not exist for example. However, the structure of the taxonomies 40 can show that the query terms “dinosaur in a haystack” are also linked to the expression “theory of evolution”. This latter expression is linked to the precursor of “evolution” found in the specific-topic taxonomy of biology and natural sciences. The precursor of “evolution” is further linked to different facets and facet values. Therefore, in response to the user's query, text documents concerning evolution and the theory of evolution will also be shown to the user in addition to text objects containing the precursor of “dinosaur”.

FIG. 13 illustrates the results obtained after entering a multi-concept query, such as terms A and D. The text objects containing the precursor p(A) derived from the noun-phrase AB are found, the precursor p(A) is further linked to a facet f(A) and associated facet values fv(A). In addition, D has been identified as a valid noun-phrase occurring directly as is in the text object. Therefore, in the result set, the user will be presented with this text object (D), the facet f(A) associated with A as well as any other facet values fv(A) which have also occurred in the document along with the conceptual unit D.

It is to be understood that the invention is not limited in its application to the details of construction and parts illustrated in the accompanying drawings and described hereinabove. The invention is capable of other embodiments and of being practiced in various ways. It is also to be understood that the phraseology or terminology used herein is for the purpose of description and not limitation. Hence, although the present invention has been described hereinabove by way of illustrative embodiments thereof, it can be modified, without departing from the spirit, scope and nature of the subject invention as defined in the appended claims.

What is claimed is:

1. A method for conducting a query-based search in documents provided on a network, the method comprising:
classifying text objects contained in the documents using a faceted classification;
determining a precursor in a query;
identifying the determined precursor in the faceted classification; and
upon identification of the determined precursor in the faceted classification, returning both a set of text objects related to the identified precursor and a set of unexpected results defined by facets and facet values associated with the determined precursor.

2. The query-based search method recited in claim 1, wherein classifying text objects using a faceted classification includes associating at least one facet to each text object.

3. The query-based search method recited in claim 2, wherein classifying text objects using a faceted classification further includes associating at least one facet value to each text object.

4. The query-based search method recited in claim 1, wherein classifying text objects using a faceted classification includes using a tree-type structure of taxonomies.

5. The query-based search method recited in claim 4, wherein the tree-type structure of taxonomies includes a first level of verticals, a second level of themes, a third level of facets, a fourth level of facet values and a fifth level of semantic expansion.

6. The query-based search method recited in claim 4, wherein classifying text objects using a faceted classification using the tree-type structure of taxonomies comprises:
tokenizing the text objects to produce a sequence of tokens;
parsing the sequence of tokens to extract conceptual units;
determining a precursor in the extracted conceptual units;
identifying relevant concepts related to the determined precursor in the tree-type structure of taxonomies; and
linking the text objects to the relevant concepts identified in the tree-type structure of taxonomies.

7. The query-based search method recited in claim 6, further comprising:
associating a theme from the tree-type structure of taxonomies to each text object using a tag; and
assigning a specific-topic theme to the text object for identifying a topical content thereof.

8. The query-based search method recited in claim 6, wherein determining the precursor in the extracted conceptual units comprises using a binding process to associate the sequence of tokens to the precursor.

9. The query-based search method recited in claim 6, wherein linking the text objects to the relevant concepts comprises linking the determined precursor to facets representing relevant concepts in the tree-type structure of taxonomies.

10. The query-based search method recited in claim 9, wherein linking the determined precursor to the facets representing the relevant concepts comprises applying category tags, corresponding to the relevant concepts, to the text objects.

11. The query-based search method recited in claim 9, wherein linking the determined precursor to the facets further comprises linking a cluster of additional information.

12. The query-based search method recited in claim 11, wherein the cluster of additional information includes at least one facet value associated to the facets.

13. The query-based search method recited in claim 1, wherein classifying the text objects using a faceted classification includes storing the faceted classification in a reverse index.

14. The query-based search method recited in claim 13, wherein storing the faceted classification in the reverse index includes storing at a given position: the text object, an identification tag for the text object, a facet associated to the text object and corresponding to the determined precursor, a facet value associated to the facet, and other facet values which are siblings of the facet value.

15. The query-based search method recited in claim 1, wherein classifying the text objects using a faceted classification includes linking concepts semantically related to a text object.

16. The query-based search method recited in claim 15, wherein classifying the text objects using a faceted classification includes determining crossed-over concepts through related terms, the crossed-over concepts having a relation between each other selected from the group consisting of a cultural relation, a contextual relation and a linguistic relation.

17. The query-based search method recited in claim 15, wherein classifying the text objects using a faceted classification includes determining crossed-over concepts, issued from different topics, through associated terms.

18. The query-based search method recited in claim 1, wherein determining the precursor from the entered query comprises:
tokenizing the query to produce a sequence of tokens;
parsing the sequence of tokens to extract conceptual units; and
determining the precursor in the extracted conceptual units.

19. The query-based search method recited in claim 18, further comprising dividing the query into two lists of queries; a first list including query elements and a second list including filtering elements.

20. The query-based search method recited in claim 19, wherein the query elements comprise the determined precursor from the entered query.

21. The query-based search method recited in claim 20, wherein identifying the determined precursor in the faceted classification comprises:
submitting the list of query elements to the faceted classification; and
searching for a match between the query elements and the text objects classified in the faceted classification.

22. The query-based search method recited in claim 21, wherein returning the set of text objects includes accumulating the text objects identified in the faceted classification and facets linked to the identified text objects in an answer set.

23. The query-based search method recited in claim 22, wherein returning the set of text objects further comprises accumulating text objects and facets linked thereto, associated to precursors which are related to the determined precursor, in the answer set.

24. The query-based search method recited in claim 23, wherein returning the set of text objects further comprises presenting to the user a combination of concepts semantically related to the entered query.

25. The query-based search method recited in claim 23, further comprising applying a filter to the answer set, the filter containing at least one element of the list of filtering elements to keep text objects that correspond to the filtering elements in the answer set.

26. The query-based search method recited in claim 25, further comprising calculating a score and rank of the text objects kept in the answer set so as to determine relevant facets to be presented to the user.

27. The query-based search method recited in claim 1, further comprising refining the query entered by the user by adding to the query at least one element selected from the set of unexpected results.

28. The query-based search method recited in claim 27, wherein refining the query comprises:
selecting a specific facet in the set of unexpected results; and
displaying the list of search results corresponding to the selected facet.

29. A system for conducting a query-based search in documents provided on a network, the device comprising:
means for classifying text objects contained in the documents according to a faceted classification;
means for determining a precursor in a query;
means for identifying the determined precursor in the faceted classification; and
upon identification of the determined precursor in the faceted classification, means for returning both a set of text objects corresponding to the identified precursor and a set of unexpected results defined by facets and facet values associated with the determined precursor.

30. A system for conducting a query-based search in documents provided on a network, the device comprising:
a semantic indexing server so configured as to classify text objects contained in the documents according to a faceted classification;
an identifier so configured as to determine a precursor in a query;
a query server so configured as to identify the determined precursor in the faceted classification; and
a result handler so configured as to return both a set of text objects related to the identified precursor and a set of unexpected results defined by facets and facet values associated with the determined precursor.

31. The query-based search system recited in claim 30, wherein the semantic indexing server associates at least one facet to each text object.

32. The query-based search system recited in claim 31, wherein the semantic indexing server further associates at least one facet value to each text object.

33. The query-based search system recited in claim 31, wherein the semantic indexing server is so configured as to use a tree-type structure of taxonomies.

34. The query-based search system recited in claim 33, wherein the tree-type structure of taxonomies comprises a first level of verticals, a second level of themes, a third level of facets, a fourth level of facet values and a fifth level of semantic expansion.

35. The query-based search system recited in claim 34, wherein the semantic indexing server comprises:
a tokenizer so configured as to tokenize the text objects to produce a sequence of tokens;
a parser so configured as to parse the sequence of tokens to extract conceptual units;
a first identifier so configured as to determine a precursor in the extracted conceptual units;
a second identifier so configured as to identify relevant concepts related to the determined precursor in the tree-type structure of taxonomies; and
an indexer so configured as to link the text objects to the relevant concepts identified in the tree-type structure of taxonomies.

36. The query-based search system recited in claim 35, wherein the indexer further associates a theme of the tree-type structure of taxonomies to each text object using a tag and assigns a specific-topic theme to the text object for identifying a topical content thereof.

37. The query-based search system recited in claim 35, wherein the second identifier uses a binding process to associate the sequence of tokens to the precursor.

38. The query-based search system recited in claim 35, wherein the indexer links the determined precursor to facets representing the relevant concepts identified in the tree-type structure of taxonomies.

39. The query-based search system recited in claim 38, wherein the indexer further applies category tags, corresponding to the relevant concepts, to the text objects.

40. The query-based search system recited in claim 38, wherein the indexer further links a cluster of additional information to the facets representing the relevant concepts; the cluster of additional information including at least facet values associated to the facets.

41. The query-based search system recited in claim 30, further comprising a storage element for storing the faceted classification in a reverse index.

42. The query-based search system recited in claim 41, wherein the storage for storing the faceted classification stores at a given position: the text object, an identification tag for the text object, a facet associated to the text object and corresponding to the determined precursor, a facet value associated to the facet, and other facet values which are siblings of the facet value.

43. The query-based search system recited in claim 30, wherein the semantic indexing server links a text object and concepts semantically related to the text object together.

44. The query-based search system recited in claim 30, wherein the semantic indexing server determines crossed-over concepts through related terms, the crossed-over concepts having a relation between each other selected from the group consisting of a cultural relation, a contextual relation and a linguistic relation.

45. The query-based search system recited in claim 30, wherein the semantic indexing server determines crossed-over concepts, issued from different topics, through associated terms.

46. The query-based search system recited in claim 30, wherein the query server comprises:
a tokenizer so configured as to tokenize the query to produce a sequence of tokens;
a parser so configured as to parse the sequence of tokens into extract conceptual units; and
an identifier so configured as to determine a precursor in the extracted conceptual units.

47. The query-based search system recited in claim 46, wherein the query server is so configures as to divide the query into two lists of queries; a first list including query elements and a second list including filtering elements.

48. The query-based search system recited in claim 47, wherein the query elements include the determined precursor.

49. The query-based search system recited in claim 48, wherein the identifier submits the list of query elements to the faceted classification and searches for a match between the query elements and the text objects classified in the faceted classification.
